(19) United States
(12) Patent Application Publication
(10) Pub. No.: US 2024/0223857 A1
(43) Pub. Date: Jul. 4, 2024

(54) PERFORMING CONTEXT BASED DELIVERY OF DIGITAL CONTENT

(71) Applicant: International Business Machines Corporation, Armonk, NY (US)

(72) Inventors: Sarbajit K. Rakshit, Kolkata (IN); Raghuveer Prasad Nagar, Kota (IN); Sidharth Ullal, Chennai (IN); Reji Jose, Bangalore (IN)

(21) Appl. No.: 18/092,065

(22) Filed: Dec. 30, 2022

(51) Int. Cl. H04N 21/4627; H04N 7/01; H04N 21/2543

(52) U.S. Cl. CPC H04N 21/4627; H04N 7/01; H04N 21/2543

(57) ABSTRACT

A computer-implemented method dynamically transforming digital content includes receiving a request for digital content from a digital device, receiving configuration information associated with the digital device, account constraints associated with a user of the digital device, and information on resources available on the digital device, identifying an alternative output event based on the configuration information, the account constraints, and the information on resources available on the digital device, and executing the alternative output event. A system and computer program product corresponding to the above method are also disclosed herein.

### BACKGROUND

The subject matter disclosed herein relates generally to delivery of digital content and specifically to providing digital data to a variety of different end devices.

Currently, devices of various types receive a variety of digital content from content providers. The provided digital content can be quite large, thereby taxing data delivery components as well as the receiving device.

### SUMMARY OF THE DISCLOSED EMBODIMENTS

A computer-implemented method for delivering digital content includes receiving a request for digital content from a digital device, receiving configuration information associated with the digital device, account constraints associated with a user of the digital device, and information on resources available on the digital device. The method also includes identifying an alternative output event based on the configuration information, the account constraints, and the resources available on the digital device, and executing the alternative output event.

A system and computer program product that corresponding to the above method are also disclosed herein. The computer program product includes a computer readable storage medium having program instructions embodied therewith, wherein the computer readable storage medium is not a transitory signal per se, the program instructions executable by a processor to cause the processor to conduct the above method. The system includes one or more processors and a computer-readable storage medium similar to the computer readable storage medium that is included in the computer program product.

### BRIEF DESCRIPTION OF THE DRAWINGS

In order that the advantages of the disclosed embodiments will be readily understood, a more particular description of the embodiments briefly described above will be rendered by reference to specific embodiments that are illustrated in the appended drawings. Understanding that these drawings depict only some embodiments and are therefore not to be considered to be limiting of scope, the embodiments will be described and explained with additional specificity and detail through the use of the accompanying drawings, in which:

FIG. 1 is a block diagram illustrating various portions of a computing environment in accordance with at least one embodiment disclosed herein; and

FIG. 2 is a flowchart of one example of a method for delivering digital content to end user devices in accordance with at least one embodiment disclosed herein;

FIG. 3 is a flowchart of one example of a method for executing an alternative output event in accordance with at least one embodiment disclosed herein;

FIG. 4 is a flowchart of one example of a method for dynamically transforming digital content in accordance with at least one embodiment disclosed herein;

FIG. 5 is a flowchart of one example of a method for dynamically transforming digital content in accordance with at least one embodiment disclosed herein;

FIG. 6 is a flowchart of one example of a method for identifying an alternative output event in accordance with at least one embodiment disclosed herein;

FIG. 7 is a flowchart of one example of a method for delivering digital content to end user devices in accordance with at least one embodiment disclosed herein; and

FIG. 8 is a block diagram illustrating one example of a computing stack in accordance with at least one embodiment disclosed herein.

### DETAILED DESCRIPTION OF THE DISCLOSED EMBODIMENTS

One of ordinary skill in the art will appreciate that references throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The technology and solutions disclosed herein makes delivery of digital content more efficient.

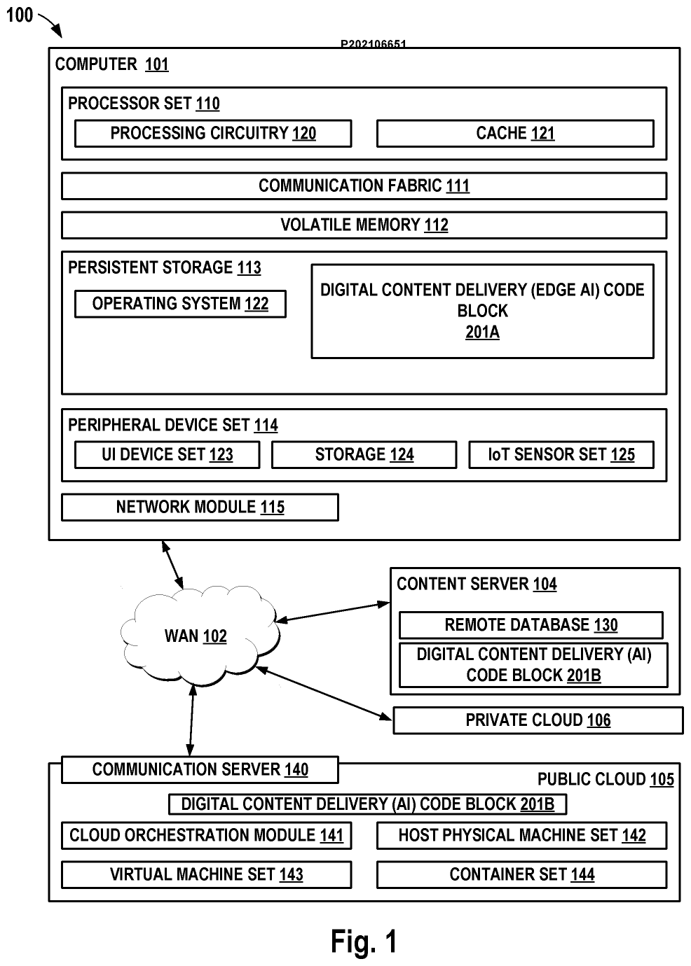

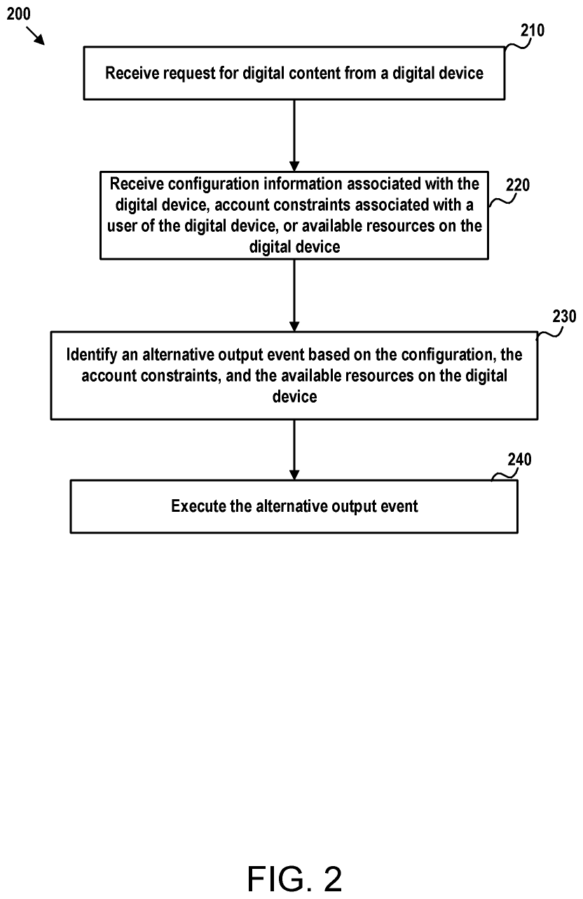

FIG. 1 is a block diagram illustrating various portions of a computing environment 100 in accordance with at least one embodiment disclosed herein. Computing environment 100 illustrates one example of an environment for the execution of at least some of the computer code involved in performing the inventive methods or processes, such as code blocks 201A, B (corresponding to the method 200 shown in FIG. 2). In some embodiments, portions of code block 201A reside within the operating system 122. In addition to blocks 201A, B, computing environment 100 includes, for example, computer 101, wide area network (WAN) 102, content server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201A, as identified above), peripheral device set 114 (including user interface (UI) device set 123, storage 124, and output device(s) 125), and network module 115. Content server 104 includes remote database 130. Public cloud 105 includes communication device 140, cloud orchestration module 141, host physical machine set 142, virtual machine set 143, and container set 144. Communication device 140 includes storage having code block 201B and processor for executing the contents of the code block 201B.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented process, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in blocks 201A and/or B.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201A typically includes at least some of the computer code involved in performing the inventive methods such as provisioning cloud computing clusters and associated resources.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Output device(s) 125 is made up of audio, visual, and/or haptic output devices configured to output converted/transformed digital content. For example, one output device may be a display and another output device may be a speaker.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

CONTENT SERVER 104 is any computer system that serves at least some data and/or functionality to computer 101. Content server 104 may be controlled and used by the same entity that operates computer 101. Content server 104 represents the machine(s) that collect and store helpful and useful data for use by other computers, such as computer 101. For example, in a hypothetical case where computer 101 is designed and programmed to provide digital content to computer 101.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Communication device 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 is a flowchart of one example of a method 200 for delivering digital content to end user devices in accordance with at least one embodiment disclosed herein. As depicted, the method 200 includes receiving (210) a request for digital content from a digital device, receiving (220) configuration information associated with the digital device, account constraints associated with a user of the digital device, and/or information on resources available on the digital device, identifying (230) an alternative output event based on the configuration information, the account constraints, and the information on resources available on the digital device, and executing (240) the alternative output event. The depicted method reduces the transmission delay and/or data usage associated with downloads of large digital content (e.g., video, audio).

Receiving (210) the request for digital content from a digital device may include receiving a request that specifies specific digital content (e.g. sound (e.g., song, podcast, or the like), video (e.g., movie, live broadcast video, or the like)). The request may be sent to communication server and/or content server.

Receiving (220) the configuration information associated with the digital device may include configuration information of the digital device or other digital devices associated with a user associated with the request. The configuration information may include the type of device, such as, without limitation, smartphone, laptop, smartwatch, or the like. Receiving (220) the account constraints associated with the user of the digital device may include information of a content provider service, such as, without limitation, a streaming audio or video service, that provides digital content at a variety of quality levels. Receiving (220) the information on available resources may include information associated with amount of memory or download capabilities of the digital device or the other digital devices, amount of data available to the digital device or the other digital devices at a current/lower billing cycle rate, or comparable resource information.

Identifying (230) an alternative output event based on the configuration information, the account constraints, and the information on resources available on the digital device may include identifying a type of output event that is an alternative to simply sending the requested digital content and output the digital content on the digital device without any alteration. Example alternative output events are described below.

Executing (240) the alternative output event may include altering the requested digital content from a default quality level to one that is more compatible with the digital device or the other digital devices. Alternative output events may include degrading the quality of the digital content, removing peripheral data (e.g., reference, header, footer, credits, or the like), or improving the quality of the digital content.

One of skill in the art will appreciate that the above method for delivering digital content to end user devices enables more efficient consumption of digital content. Consequently, bandwidth can be reduced or redirected to improve users' digital content consumption experiences.

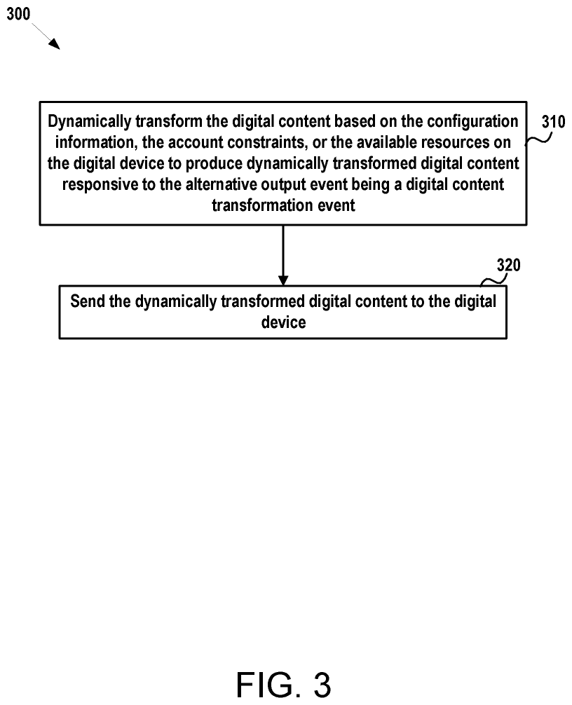

FIG. 3 is a flowchart of one example of an alternative output method 300 in accordance with at least one embodiment disclosed herein. As depicted, the executing 300 includes dynamically transforming (310) the digital content based on the configuration information, the account constraints, and/or the information on resources available on the digital device to produce dynamically transformed digital content responsive to the alternative output event being a digital content transformation event and sending (320) the dynamically transformed digital content to the digital device or the other digital devices. The alternative output method 300 is one example of the executing operation 240 depicted in FIG. 2.

Dynamically transforming (310) the digital content may include altering the digital content in order to be compatible with the configuration information, the account constraints, and/or the information on resources available on the digital device. Altering of the digital content may be defined by the digital content delivery module code blocks (201A,B) (i.e., artificial intelligence (AI) module, edge AI module) based on historical information of digital content received by the digital device, the configuration information, the account constraints, and/or the information on resources available on the digital device.

Sending (320) the dynamically transformed digital content to the digital device may include sending the altered digital content to the digital device or the other digital devices. Transmission may be through different data routes (e.g., cellular data network, public or private wired data network, or the like) depending upon the identified alternative output event.

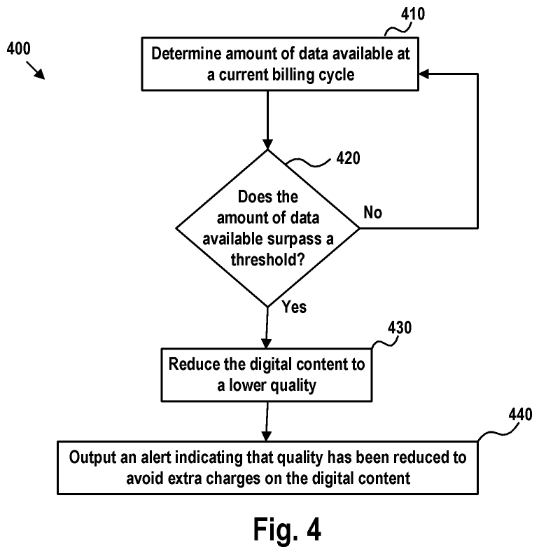

FIG. 4 is a flowchart of one example of dynamic transformation method 400 in accordance with at least one embodiment disclosed herein. As depicted, the dynamic transformation method 400 includes determining (410) amount of data available at a current billing cycle, determining (420) if the determined amount of data available surpass a threshold, reducing (430) the digital content to a lower quality, and outputting (440) an alert indicating that quality has been reduced to avoid extra charges on the digital content. The dynamic transformation method 400 is one example of the dynamically transforming operation 310 depicted in FIG. 3.

Determining (410) amount of data available at a current billing cycle may include receiving billing rate information and amount of data used in a particular billing cycle from a data controlling authority, such as, without limitation, communication server, network provider, cell data provider, or the like.

Determining (420) if the determined amount of data available surpass a threshold may include receiving data download threshold information from the data controlling authority for an account associated with the user of the digital device.

Outputting (440) an alert may include sending a text message or other message. The message may be sent thru a different communication means (e.g., cell network, email system) to the user or may be sent with the digital content to be presented to the user.

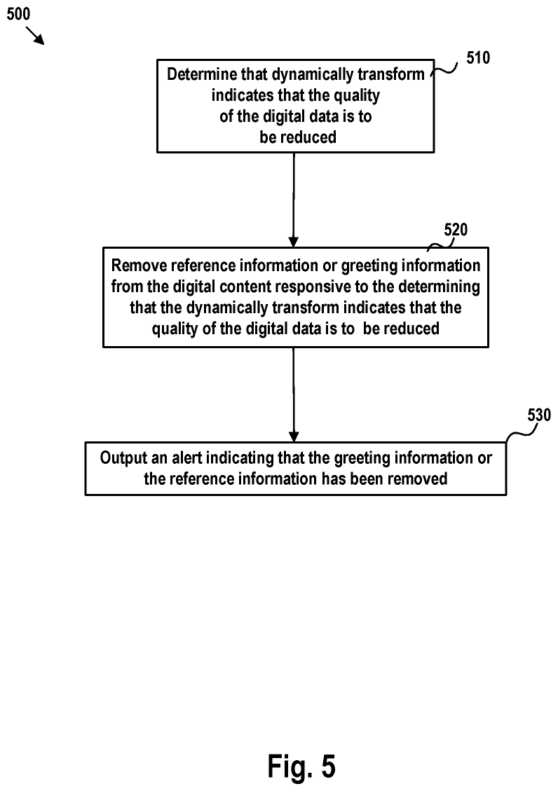

FIG. 5 is a flowchart of one example of dynamic transformation method 500 in accordance with at least one embodiment disclosed herein. As depicted, dynamically transforming method 500 may include determining (510) that dynamically transform indicates that the quality of the digital data is to be reduced, removing (520) reference information and/or greeting information from the digital content responsive to determining that the dynamically transform indicates that the quality of the digital data is to be reduced, and outputting (530) an alert indicating that the greeting information and/or the reference information has been removed. The dynamic transformation method 500 is one example of the dynamically transforming operation 310 depicted in FIG. 3.

Determining (510) that dynamically transform indicates that the quality of the digital data is to be reduced is determined by analysis of historical data related to previous digital content delivery to the digital device or comparable digital devices, the configuration information, the account constraints, and/or the information on resources available on the digital device.

Removing (520) reference information and/or greeting information from the digital content may include removing data/information (e.g., introduction text, credit text, metadata information of the digital content, or comparable data) extraneous to primary deliverable content (e.g., movie, music, or the like).

Outputting (530) the alert indicating that the greeting information or the reference information has been removed may include sending a text message or other message thru a different communication means (e.g., cell network, email system) to the user. The alert may include a link to the removed greeting information or reference information.

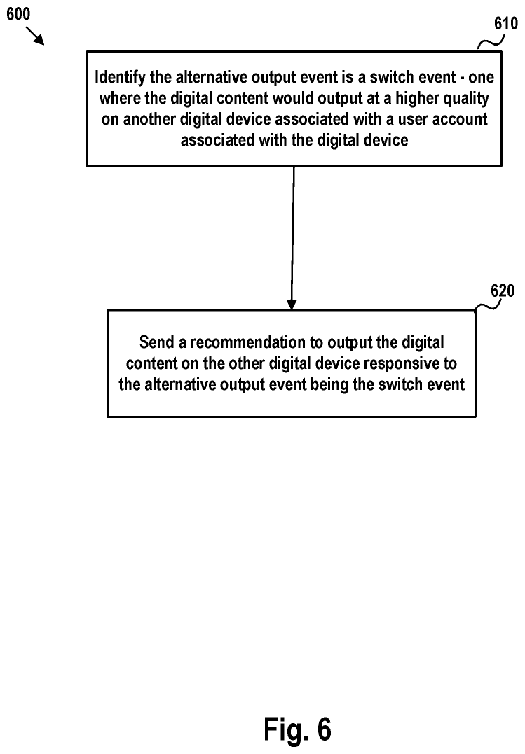

FIG. 6 is a flowchart of one example of a method 600 in accordance with at least one embodiment disclosed herein. As depicted, the method 600 includes an identifying operation 610 that the alternative output event is a switch event and a sending operation 620 a recommendation to output the digital content on the other digital device responsive to the alternative output event being the switch event. The identifying operation 610 is an example of the identifying operation 230 depicted in FIG. 2. The sending operation 620 is one example of the executing operation 240 also depicted in FIG. 2.

Identifying (610) that the alternative output event is a switch event may indicate that the digital content would output at a higher quality on another digital device associated with a user account associated with the digital device. The digital device may be a user's cell phone and the other digital device may be the user's digital television (TV). In this example, a higher quality movie can be presented on the tv vs the cell phone, thus prompting the switch event. The switch event may be initiated when location information of the digital device making the request is proximate the other digital device, thus making it easy for the user to access the other digital device.

Sending (620) the recommendation may include sending a text message or other message thru a different communication means (e.g., cell network, email system) to the user. The alert may include a link to the removed greeting information or reference information.

The methods disclosed herein may be partially or fully embodied within the digital content delivery module code blocks 201A, B shown in FIG. 1. One of skill in the art will appreciated that the methods disclosed herein may be adapted to the cloud computing environment to which they are deployed without changing the spirit and intent of the disclosed methods. One of skill in the art will also appreciate the utility and effectiveness of the methods and solutions disclosed herein.

In various embodiments, an AI and IoT (internet of things) based system and method dynamically transform digital content based on the context of receiving device and deliver the transformed content to the receiving device.

In various embodiments, an AI and IoT based system and method dynamically transforms the content based on the context of receiving device and delivers the transformed content to the receiving device where transformation decision is made based on the device-configuration, account constraints, and/or available resources on the device (e.g., user A's device is having lower configuration, so, while sending the video to user A, the video will be downgraded, like reduced file size, color fading, or the like, but user B's device configuration is higher, so the same video will be upgraded while sending the movie to user B by selecting best video file format.)

In various embodiments, an AI and IoT based system and method dynamically transforms the content based on the context of receiving device and delivers the transformed content to the receiving device where user devices are prioritized and recommendation on the best experience device is made (e.g., user A can access the received file from multiple devices, and an app (e.g., WhatsApp) can be accessed from both smart phone and laptop. If mobile device configuration is low, but laptop configuration is high, so even for the same account/user, system will not only transform to different file formats but also recommend to user A to view the higher quality video on the laptop.)

In various embodiments, an AI and IoT based system and method dynamically transforms the content based on the context of receiving device and delivers the transformed content to the receiving device where transformation decision is made at the device using edge AI module (e.g., when user starts downloading a video on smart phone, the edge AI module of the proposed system decides that user has only 1 GB data left until next bill cycle which is 10 days from now. So, system downgrades the quality from 1080p to 240p).

In various embodiments, an AI and IoT based system and method dynamically transforms the content based on the context of receiving device and delivers the transformed content to the receiving device where transformation is done at the device using edge AI with or without involving the communication/content server (e.g., When user starts downloading a 500 MB video on smart phone, after edge AI module decides to reduce size. The module further predicts the preferred size, based on the learning out of the usage of the device by the user, as 200 MB. The module then involves a third party (e.g., Gmail/YouTube) for transformation. The third party accordingly transforms the video.)

In various embodiments, an AI and IoT based system and method to dynamically transform the content based on the context of receiving device and deliver the transformed content to the receiving device where transformation consists of changes in both content and quality (e.g., When user starts downloading a 5 minute education video on smart phone, the edge AI module decides that user has only 1 GB data left until next bill cycle which is 10 days from now. So, system removes the greeting part at the beginning and the references part at the end.)

In various embodiments, an AI and IoT based system and method to dynamically transform the content based on the context of receiving device and deliver the transformed content to the receiving device where undelivered content and quality is reported along with rationale and recommendation (e.g., When user starts downloading a 5 minute education video on smart phone, after removing the greeting part at the beginning and the references part at the end, system provides a text alert to the user at the end of the transformed video that initial greeting and concluding references were removed and quality was degraded to avoid extra charges on data and the same can be experienced with completeness on the laptop using Wi-Fi.)

In various embodiments, the following may be identified: the device constraints such as operating system, memory footprint and available resources, account constraints such as data limits and high-definition plan and available resources like battery level, processor speed and screen resolution of all the devices owned by a user account.

In various embodiments, the system has an edge AI module which maintains a list of compression-decompression algorithms, file format conversion algorithms as well as AI based upscaling and downscaling algorithms, such as, with limitation, Super Resolution with OpenCV or Generative Adversarial Networks. It also maintains a corpus of the previous decisions made by it and how it impacted the final state of the device.

In various embodiments, the system also maintains a contextual metadata of the file using classification algorithms not limited to but including aspects such as timestamps, sentiment, and structure, such as, without limitation, tagging a file as having a greeting or acknowledgement. It then ranks the classified segments based on the learned file type combined with the past corpus of how the user interacts with that file type. For example, if the user spends more time on the content section of a video and skips the greetings and acknowledgement the system will rank the content portion as higher than the greeting or acknowledgement.

When a file is sent to the user, or the user tries to retrieve the file from content server, the file type/attributes is identified based on the content and metadata of the file. Based on the attributes, the process recommends the user to either download the file in the current device or switch devices for a better experience. If the user decides to switch devices, AI algorithms are used to upscale or downscale the file based on the attributes of device(s).

From the learnt corpus and the current state of the device(s) if the current operational state will lead to leaving the device in an adverse state (including complete battery drain), a request for the content server or the communication server to convert the file as per the device specifications and then send the converted file to the user specified device. Once all the changes are made and the content is delivered to the optimal device, metadata is also embedded in the file so that the choices made by the edge AI or the AI at the content server or the communication server are explainable and understandable to the user.

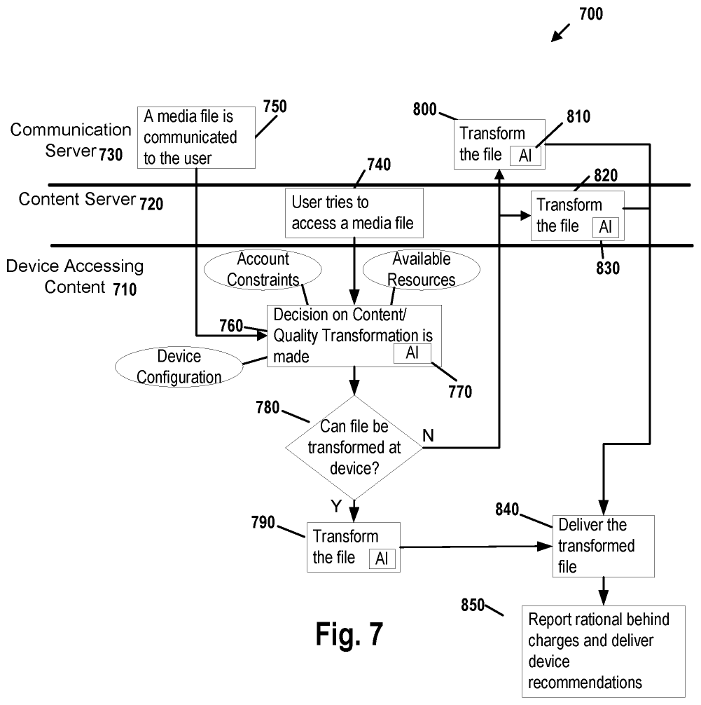

In various embodiments, FIG. 7 a flowchart of one example of a method 700 of the above described embodiments. In the method 700, user at device 710 accessing content tries to access a media file from content server 720 (operation 740). Communication server 730 communicates (operation 750) the media file to device 710. At operation 760, edge AI module 770 running on device 710 decides content/quality based on account constraint information, resources available information, and device configuration information and decides that the media file needs to be transformed. At operation 790, device 710 decides whether the media file can be transformed on device 710. If the media file cannot be transformed on device 710, then, at operation 800, the media file is transformed at communication server 730 by a resident AI module 810 or, at operation 820, the media file is transformed at content server 720 by a resident AI module 830. At operation 840, the transformed media file is delivered to device 710. At operation 850, a report is outputted indicating rational behind changes to the media file and associated recommendations.

As disclosed herein, a computer-implemented method for provisioning cloud computing clusters may include: receiving a request for digital content from a digital device; receiving configuration information associated with the digital device, account constraints associated with a user of the digital device, and information on resources available on the digital device; identifying an alternative output event based on the configuration, the account constraints, and the information on resources available on the digital device; and executing the alternative output event.

Additional features for the above method may include: determining whether to transform the content on or off device and then dynamically transforming the digital content based on configuration, account constraints and information on resources available on the digital device to produce dynamically transformed digital content; and sending the dynamically transformed digital content to the digital device wherein dynamically transforming comprises reducing the size of the digital content; dynamically transforming comprises performing color fading; dynamically transforming the digital content to a lower quality responsive to an amount of data left at a current billing cycle surpassing a threshold value; dynamically upscaling the digital content to a higher quality on device where there is sufficient compute resources such as battery life, CPU power; dynamically upscaling the digital content to a higher quality at the cloud/content server when the device has enough data and bandwidth to download a larger file; dynamically transforming includes removing a greeting part at a beginning of the digital content; dynamically transforming is performed at the digital device, a content server, or a communication server; dynamically transforming includes removing a reference within the digital content; providing a text alert to the user at the end of the transformed video; the text alert indicates that initial greeting and concluding references were removed; the text alert indicates quality is reduced to avoid extra charges on data; determining that the digital content would output at a higher quality on a second digital device associated with a user account associated with the first digital device; sending a recommendation to the user that outputting the digital content on the second digital device would present in a higher quality; providing a text alert to the user at the end of the transformed video that indicates the digital content can be experienced without quality reduction on another device associated with the user.

A system and computer program product corresponding to the above method are also disclosed herein. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

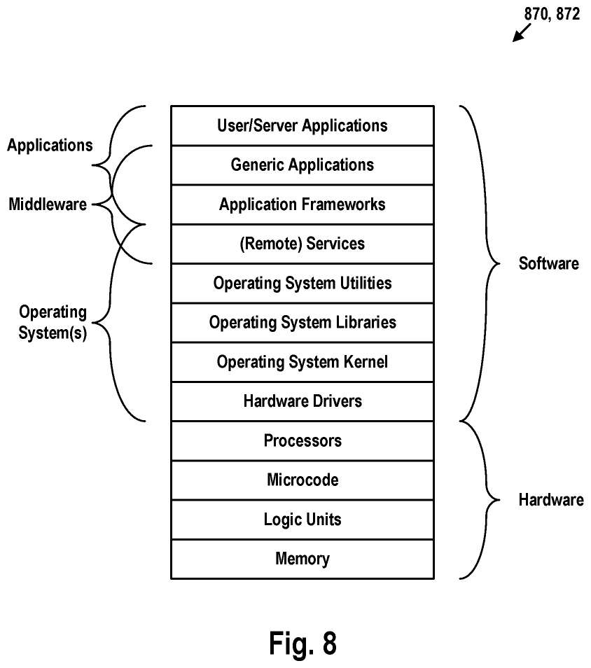

FIG. 8 is a block diagram illustrating one example of a computing stack 870 in accordance with at least one embodiment disclosed herein. As depicted, the computing stack 870 includes a number of computing layers 872 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers, and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, input/output (I/O) buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 101. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

The features, advantages, and characteristics of the embodiments described herein may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Some of the functional units described in this specification may have been labeled as modules, in order to more particularly emphasize their implementation independence. For example, a module may be implemented as a hardware circuit comprising custom VLSI (very large scale integration) circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In the preceding description, numerous specific details are provided, such as examples of programming, software modules, user selections, network transactions, database queries, database structures, hardware modules, hardware circuits, hardware chips, or the like, to provide a thorough understanding of embodiments. One skilled in the relevant art will recognize, however, that embodiments may be practiced without one or more of the specific details, or with other methods, processes, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements. The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method comprising:
receiving a request for digital content from a digital device;
receiving configuration information associated with the digital device, account constraints associated with a user of the digital device, and information on resources available on the digital device;
identifying an alternative output event based on the configuration information, the account constraints, and the resources available on the digital device; and
executing the alternative output event.

2. The method of claim 1, wherein executing the alternative output event comprises:
transforming the digital content based on the alternative output event being a transformation event, the configuration information, the account constraints, and the information on resources available on the digital device to produce dynamically transformed digital content; and
sending the dynamically transformed digital content to the digital device.

3. The method of claim 2, wherein executing the alternative output event comprises:
reducing quality of the digital content responsive to an amount of data available at a current billing cycle surpassing a threshold to produce reduced quality digital content; and
sending the reduced quality digital content to the digital device.

4. The method of claim 3, wherein executing the alternative output event further comprises outputting an alert indicating that quality has been reduced to avoid extra charges on the digital content.

5. The method of claim 2, wherein executing the alternative output event comprises removing reference information or greeting information from the digital content.

6. The method of claim 5, wherein executing the alternative output event further comprises outputting an alert indicating that the reference information or the greeting information has been removed from the digital content.

7. The method of claim 2, wherein:
identifying the alternative output event comprises determining that the digital content would output at a higher quality on another digital device associated with a user account associated with the digital device; and
executing the alternative output event comprises sending a recommendation that outputting the digital content on the other digital device would present in a higher quality.

8. A computer program product comprising a computer readable storage medium having program instructions embodied therewith, wherein the computer readable storage medium is not a transitory signal per se, wherein the program instructions are executable by a processor to cause the processor to conduct a method comprising:
receiving a request for digital content from a digital device;
receiving configuration information associated with the digital device, account constraints associated with a user of the digital device, and information on resources available on the digital device;
identifying an alternative output event based on the configuration information, the account constraints, and the information on resources available on the digital device; and
executing the alternative output event.

9. The computer program product of claim 8, wherein executing the alternative output event comprises:
transforming the digital content based on the alternative output event being a transformation event, the configuration information, the account constraints, and the information on resources available on the digital device to produce dynamically transformed digital content; and
sending the dynamically transformed digital content to the digital device.

10. The computer program product of claim 9, wherein executing the alternative output event comprises:
reducing quality of the digital content responsive to an amount of data available at a current billing cycle surpassing a threshold to produce reduced quality digital content; and
sending the reduced quality digital content to the digital device.

11. The computer program product of claim 10, wherein executing the alternative output event further comprises outputting an alert indicating that quality has been reduced to avoid extra charges on the digital content.

12. The computer program product of claim 9, wherein executing the alternative output event comprises removing reference information or greeting information from the digital content.

13. The computer program product of claim 12, wherein executing the alternative output event further comprises outputting an alert indicating that the reference information or the greeting information has been removed from the digital content.

14. The computer program product of claim 9, wherein:
identifying the alternative output event comprises determining that the digital content would output at a higher quality on another digital device associated with a user account associated with the digital device; and
executing the alternative output event comprises sending a recommendation that outputting the digital content on the other digital device would present in a higher quality.

15. A system comprising:
one or more processors; and
a computer-readable storage medium having program instructions embodied therewith, wherein the computer-readable storage medium is not a transitory signal per se, wherein the program instructions are executable by the one or more processors to cause the one or more processors to conduct a method comprising:
receiving a request for digital content from a digital device;
receiving configuration information associated with the digital device, account constraints associated with a user of the digital device, and information on resources available on the digital device;
identifying an alternative output event based on the configuration information, the account constraints, and the information on resources available on the digital device; and
executing the alternative output event.

16. The system of claim 15, wherein executing the alternative output event comprises:
transforming the digital content based on the alternative output event being a transformation event, the configuration information, the account constraints, and the information on resources available on the digital device to produce dynamically transformed digital content; and
sending the dynamically transformed digital content to the digital device.

17. The system of claim 16, wherein executing the alternative output event comprises:
reducing quality of the digital content responsive to an amount of data available at a current billing cycle surpassing a threshold to produce reduced quality digital content; and
sending the reduced quality digital content to the digital device.

18. The system of claim 16, wherein executing the alternative output event comprises removing reference information or greeting information from the digital content.

19. The system of claim 18, wherein executing the alternative output event further comprises outputting an alert indicating that the reference information or the greeting information has been removed from the digital content.

20. The system of claim 17, wherein:
identifying the alternative output event comprises determining that the digital content would output at a higher quality on another digital device associated with a user account associated with the digital device; and
executing the alternative output event comprises sending a recommendation that outputting the digital content on the other digital device would present in a higher quality.
